(19) United States
(12) Patent Application Publication
(10) Pub. No.: US 2013/0036147 A1
(43) Pub. Date: Feb. 7, 2013

(54) INFINITE IMPULSE RESPONSE (IIR) FILTER AND FILTERING METHOD

(71) Applicant: Sheng-Hong Yan, Tainan City (TW)

(72) Inventor: Sheng-Hong Yan, Tainan City (TW)

(73) Assignee: MEDIATEK INC., Hsin-Chu (TW)

(21) Appl. No.: 13/196,660

(22) Filed: Aug. 2, 2011

(51) Int. Cl. G06F 17/10

(52) U.S. Cl. 708/300

(57) ABSTRACT

An infinite impulse response (IIR) filter is provided. The IIR filter includes an amplifier and a filter coupled in a feedback path of the amplifier. The amplifier generates an output signal according to an input signal. The filter filters the output signal according to a first transfer function and provides the filtered output signal to an input of the amplifier. The IIR filter and the first filter have the same order larger than one.

### BACKGROUND OF THE INVENTION

1. Field of the Invention

The invention relates to a switched capacitor filter, and more particularly to an infinite impulse response (IIR) filter with only one amplifier.

2. Description of the Related Art

Filters are commonly used to allow passage of desired signal components and to attenuate undesired signal components. Filters are widely used for various applications such as communication, computing, networking, and consumer electronics applications, etc. For example, in a wireless communication device such as a cellular phone, filters may be used to filter a received signal to allow passage of a desired signal on a specific frequency channel and to attenuate out-of-band undesired signals and noise.

A switched capacitor filter (SCF) is used for discrete time signal processing. It works by moving charges into and out of capacitors when switches are opened and closed. Usually, non-overlapping signals are used to control the switches, so that not all switches are closed simultaneously. The major advantages of the SCF reside in the fact that only capacitors, operational amplifiers, and switches are needed, nearly perfect switches can be easily built, and, especially, all resonant frequencies are determined exclusively by capacitance ratios. Therefore, switched capacitor filters are very useful in various kinds of electronic processing systems.

In general, convectional switched-capacitor-based filters or active-RC-based filters use an amplifier (e.g. OP-AMP) to implement a pole. However, static power consumption of high-order filters is high due to the increasing number of amplifiers being required. Furthermore, flicker noise increases with the number of amplifiers used.

Therefore, for many applications, such as portable communications apparatuses, filters that consume low power are highly desired.

### BRIEF SUMMARY OF THE INVENTION

Infinite impulse response (IIR) filters and a filtering method thereof are provided. An embodiment of an IIR filter is provided. The IIR filter comprises an amplifier and a filter coupled in a feedback path of the amplifier. The amplifier generates an output signal according to an input signal. The filter filters the output signal according to a transfer function and provides the filtered output signal to an input of the amplifier. The IIR filter and the filter have the same order larger than one.

Furthermore, another embodiment of an IIR filter for providing an output signal according to an input signal is provided. The IIR filter comprises a first filter, a second filter and an integrator. The first filter filters out interference from the input signal to generate a first signal according to a first transfer function. The second filter filters the output signal to generate a second signal according to a second transfer function. The integrator generates the output signal according to the first signal and the second signal. The second filter and the integrator form a negative feedback loop.

Moreover, another embodiment of an IIR filter for providing an output signal according to an input signal is provided. The IIR filter comprises a first finite impulse response (FIR) filter, a second FIR filter and an amplifier. The first FIR filter transfers the input signal to generate a first signal. The second FIR filter transfers the output signal to generate a second signal. The amplifier receives the first signal and the second signal to generate the output signal. No amplifier is implemented in the first and second FIR filters.

Furthermore, an embodiment of a filtering method for transferring an input signal to generate an output signal according to a transfer function of an infinite impulse response (IIR) filter is provided. The input signal is transferred to generate a first signal according to a transfer function of a first finite impulse response (FIR) filter. The output signal is transferred to generate a second signal according to a transfer function of a second FIR filter. A sum of the first and second signals is integrated to obtain the output signal. A transfer function of the IIR filter is

$$\frac{B ( z )}{1 - {z}^{- 1} - {z}^{- 1} \times A ( z )} {z}^{- 1} ,$$

wherein A(z) is the transfer function of the second FIR filter and B(z) is the transfer function of the first FIR filter.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows an RF receiver according to an embodiment of the invention;

FIG. 2 shows an IIR filter according to an embodiment of the invention;

FIG. 3 shows a block diagram illustrating a transfer function model of the IIR filter of FIG. 2 in a z-domain according to an embodiment of the invention;

FIG. 4 shows a block diagram illustrating a transfer function model of the FIR filter of FIG. 2 in a z-domain according to an embodiment of the invention;

FIG. 5A shows an example of a K-path structure according to an embodiment of the invention;

FIG. 5B shows a timing diagram illustrating the control signals S₁-S_{K} of the K-path structure of FIG. 5A;

FIG. 6A shows an example of a K-path structure according to another embodiment of the invention;

FIG. 6B shows a timing diagram illustrating the control signals S₁-S_{K} of the K-path structure of FIG. 6A;

FIG. 7A shows an example of a K-path structure according to another embodiment of the invention;

FIG. 7B shows a timing diagram illustrating the control signals S₁-S_{K}, Dᵢ and Dₒ of the K-path structure of FIG. 7A;

FIG. 8A shows an example of a 2^{nd} order IIR filter according to an embodiment of the invention;

FIG. 8B shows a timing diagram illustrating the control signals S₁₁, S₁₂, S₂₁, S₂₂, S₂₃, Dᵢ and Dₒ of the K-path structure of FIG. 8A.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Analog and digital baseband (ADBB) receivers usually operate on signals occupying a subset of the whole operating bandwidth of an RF receiver. Such a subset is called a channel. However, interference may occur during operation of the RF receiver by the RF transmitter when the RF receiver and the RF transmitter are implemented in the same communications apparatus; even though the frequency spectrum of the RF transmitter does not overlap with the RF receiver. Out-of-channel interferences, especially nearby interferences, may cause severe damage to ADBB receivers, such as desensitization, cross-modulation, inter-modulation, saturation, synchronization errors, channel equalization errors and so on. Therefore, it is necessary to suppress nearby (out-of-channel) interferences for an RF receiver.

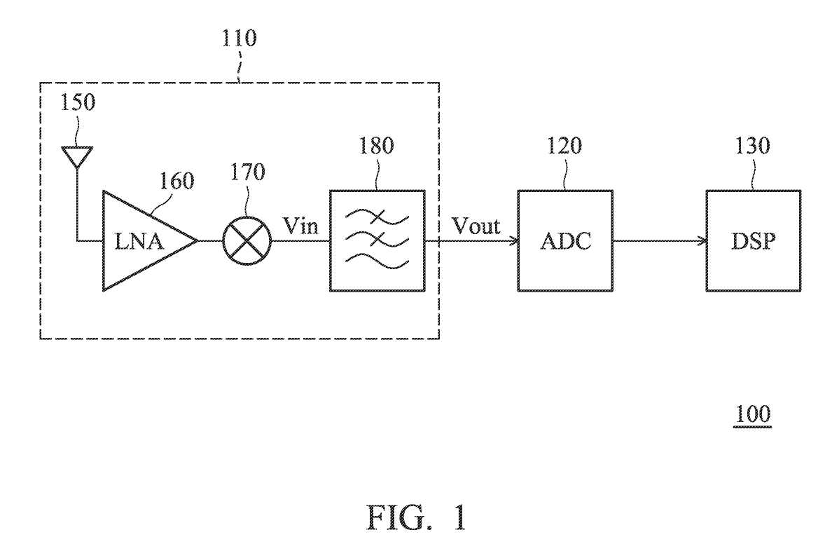

FIG. 1 shows an RF receiver 100 according to an embodiment of the invention. In the embodiment, the RF receiver 100 may be a digital-intensive or digital-assisted receiver, which comprises a pre-processing unit 110, an analog to digital converter (ADC) 120, and a digital signal processor (DSP) 130. The pre-processing unit 110 comprises an antenna 150, a low noise amplifier (LNA) 160, a mixer 170 and a filter 180. The RF receiver 100 is deigned to operate in a specific bandwidth resource. The antenna 150 receives radio frequency (RF) modulated signals transmitted by base stations and provides a received RF signal to the low noise amplifier 160. The low noise amplifier 160 amplifies the received RF signal and provides an amplified RF signal to the mixer 170. The mixer 170 may down-convert the amplified RF signal to obtain a signal Vin. The filter 180 filters the signal Vin to obtain a filtered signal Vout. The filter 180 is an infinite impulse response (IIR) filter which is used to suppress nearby interferences (e.g. adjacent or alternative channel interferences). The analog to digital converter 120 converts the signal Vout to obtain the digital samples. The digital signal processor 130 may process the digital samples to obtain decoded data and signaling for subsequent processing.

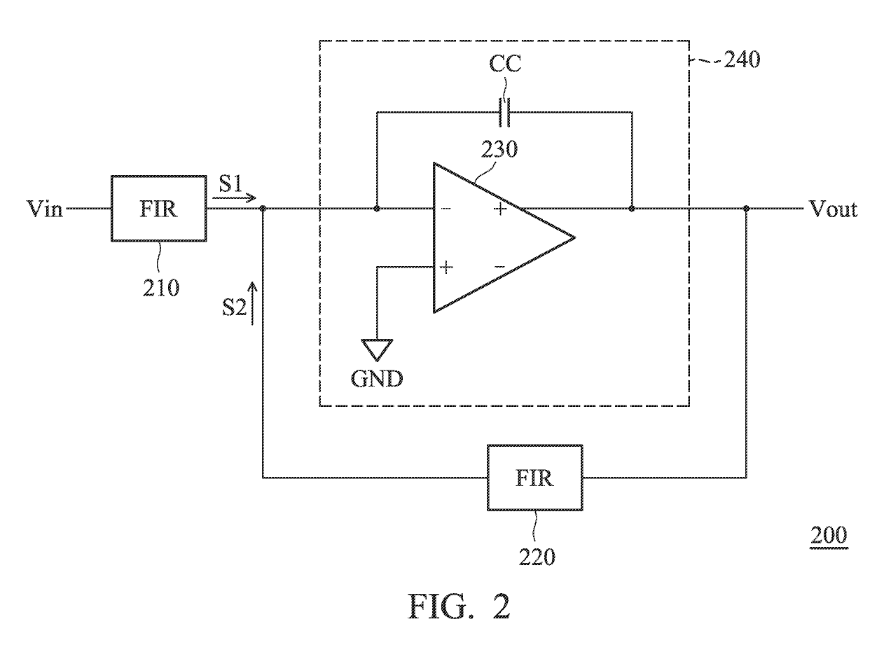

FIG. 2 shows an IIR filter 200 according to an embodiment of the invention. The IIR filter 200 comprises a finite impulse response (FIR) filter 210, a FIR filter 220, an amplifier 230 and a capacitor CC. The FIR filter 210 is coupled between the amplifier 230 and the mixer 170 of FIG. 1, wherein the FIR filter 210 transfers an input signal Vin, to provide a signal 51 to the amplifier 230. The FIR filter 220 is coupled in a feedback path of the amplifier 230, wherein the FIR filter 220 transfers an output signal Vout from the amplifier 230, to provide a signal S2 to the inverting input of the amplifier 230. A non-inverting input of the amplifier 230 is coupled to a ground GND, and the amplifier 230 generates the output signal Vout according to the signal S1 from the FIR filter 210 and the signal S2 from the FIR filter 220. Furthermore, the capacitor CC is coupled to the FIR filter 220 in parallel, such that the amplifier 230 and the capacitor CC may form an integrator 240 for integrating the signals S1 and S2 to obtain the output signal Vout. Note that each of the FIR filters 210 and 220 is a switched-capacitor filter without any amplifier, i.e. no amplifier is implemented in the FIR filters 210 and 220. Furthermore, the IIR filter 200 and the FIR filter 220 have the same order larger than one. Details of the FIR filters 210 and 220 are described below. Thus, the IIR filter 200 is a switched-capacitor filter with only one amplifier (i.e. 230), thereby power consumption and flicker noise are decreased.

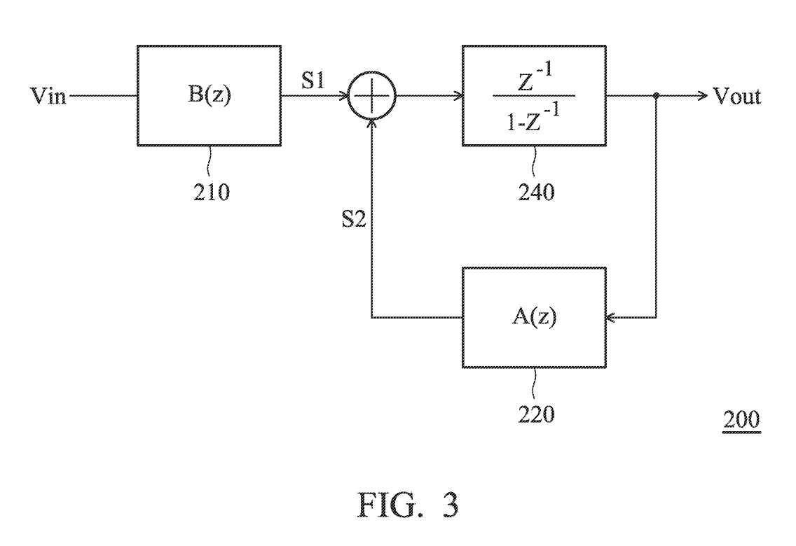

FIG. 3 shows a block diagram illustrating a transfer function model of the IIR filter 200 in a z-domain according to an embodiment of the invention. In FIG. 3, the FIR filter 210 has a transfer function B(z), the FIR filter 220 has a transfer function A(z), and the integrator 240 has a transfer function

$$\frac{{z}^{- 1}}{1 - {z}^{- 1}} .$$

Therefore, the FIR filter 210 filters out interference from the input signal Vin to generate the signal S1 according to the transfer function B(z), and the FIR filter 220 filters the output signal Vout to generate the signal S2 according to the transfer function A(z). The integrator 240 integrates a sum of the signals S1 and S2 according to the transfer function

$$\frac{{z}^{- 1}}{1 - {z}^{- 1}} ,$$

to obtain the output signal Vout. Thus, a transfer function H_{IIR}(z) of the IIR filter 200 is given by the following equation:

$$\begin{matrix}{H}_{IIR} ( z ) = \frac{Vout}{Vin} \\ = \frac{\frac{{z}^{- 1}}{1 - {z}^{- 1}} \times B ( z )}{1 - \frac{{z}^{- 1}}{1 - {z}^{- 1}} \times A ( z )} \\ = \frac{B ( z )}{1 - {z}^{- 1} - {z}^{- 1} \times A ( z )} {z}^{- 1} .\end{matrix}$$

Therefore, zeros of the IIR filter 200 are determined by the FIR filter 210, and poles of the IIR filter are determined by the FIR filter 220. In FIG. 3, the input signal Vin comprising a desired signal and interferences is transmitted to the FIR filter 210 first to suppress the nearby interferences. Furthermore, the integrator 240 and the FIR filter 220 are used to pass the desired signal and reject out-of-channel interferences.

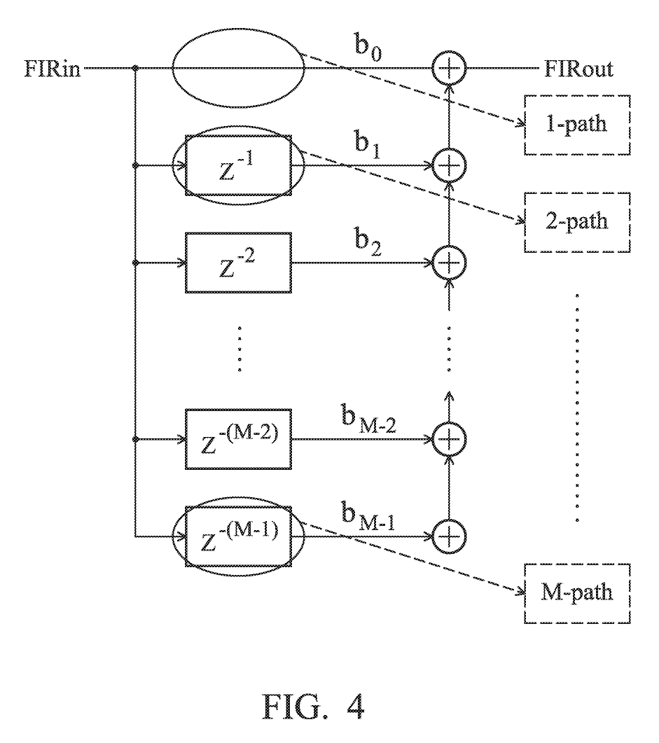

FIG. 4 shows a block diagram illustrating a transfer function model of the FIR filter 210 or 220 in a z-domain according to an embodiment of the invention. For a FIR filter, impulse response is finite because there is no feedback in the FIR filter. In FIG. 4, a transfer function H_{FIR}(z) of a FIR filter is given by the following equation:

$$\begin{matrix}{H}_{FIR} ( z ) = {\sum }_{i = 0}^{M - 1} {b}_{i} {Z}^{- i} \\ = {b}_{0} + {b}_{1} {Z}^{- 1} + {b}_{2} {Z}^{- 2} + … + {b}_{M - 1} {Z}^{- ( M - 1 )} ,\end{matrix}$$

wherein the FIR filter is a M-tap filter. In order to implement the unit delays for every tap of the transfer function H_{FIR}(z), a K-path structure is used, wherein K=1, 2, . . . , M. For example, a 1-path structure is implemented in the path corresponding to coefficient b₀, a 2-path structure is implemented in the path corresponding to coefficient b₁, a 3-path structure is implemented in the path corresponding to coefficient b₂, and so on.

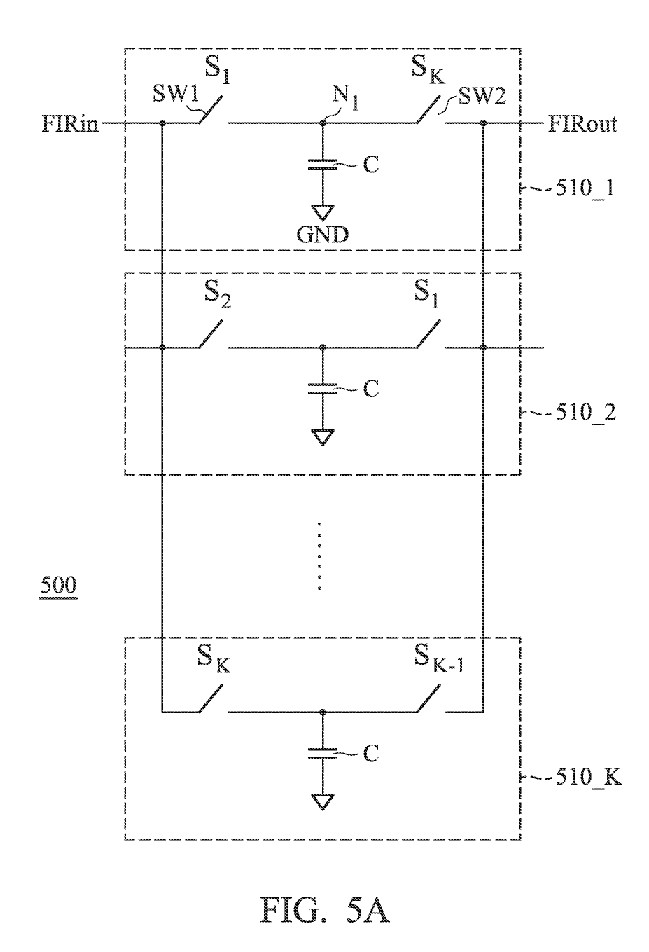

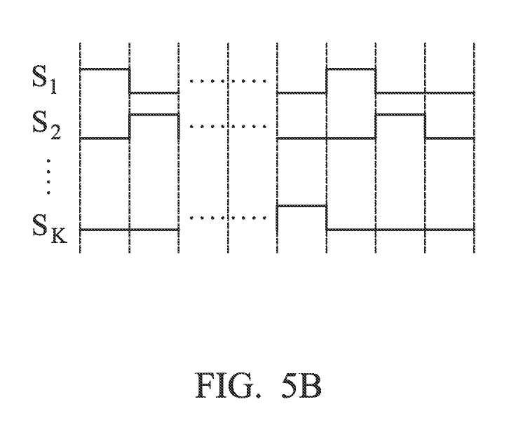

FIG. 5A shows an example of a K-path structure 500 according to an embodiment of the invention, and FIG. 5B shows a timing diagram illustrating the control signals S₁-S_{K} of the K-path structure of FIG. 5A. The K-path structure 500 comprises a plurality of passive switched capacitor units 510_1 to 510_K connected in parallel, wherein each passive switched capacitor unit has the same structure. Taking the passive switched capacitor unit 510_1 as an example, the passive switched capacitor unit 510_1 comprises a switch SW1, a switch SW2 and a capacitor C. The switch SW1 is coupled between an input of the passive switched capacitor unit 510_1 and a node N₁, wherein the switch SW1 is controlled by the control signal S₁. The switch SW2 is coupled between an output of the passive switched capacitor unit 510_1 and the node N₁, wherein the switch SW2 is controlled by the control signal S_{K}. The capacitor C is coupled between the node N₁ and the ground GND. For each tap of a FIR filter, its coefficient is determined according to the capacitors C of the K-path structure 500. In each of the passive switched capacitor units 510_1 to 510_K, only one switch is turned on at a time. Furthermore, only one control signal is present in the K-path structure 500 at a time, i.e. the control signals S₁-S_{K} are not present at the same time, as shown in FIG. 5B.

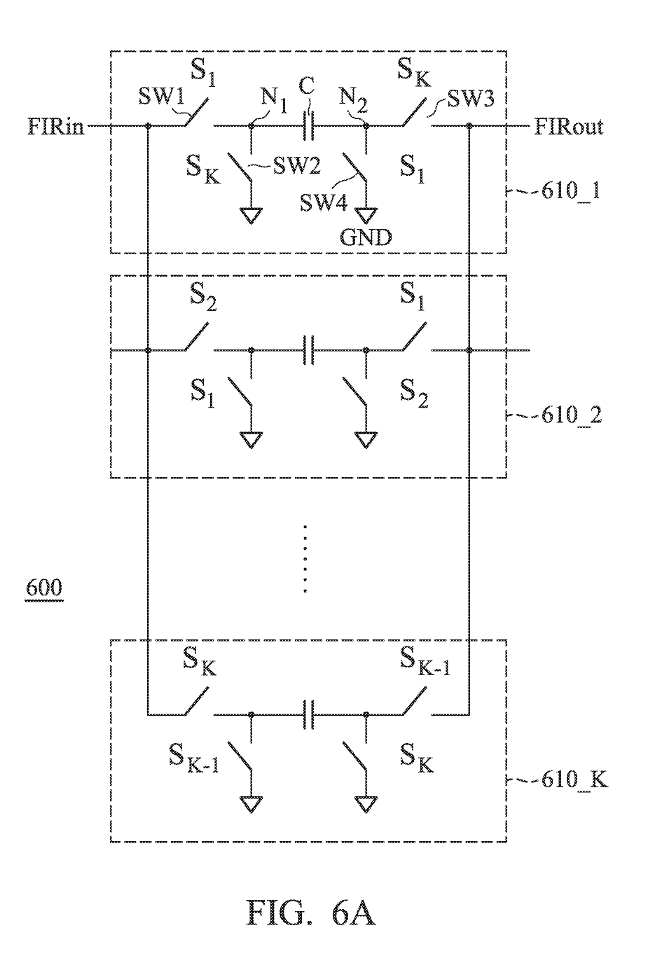

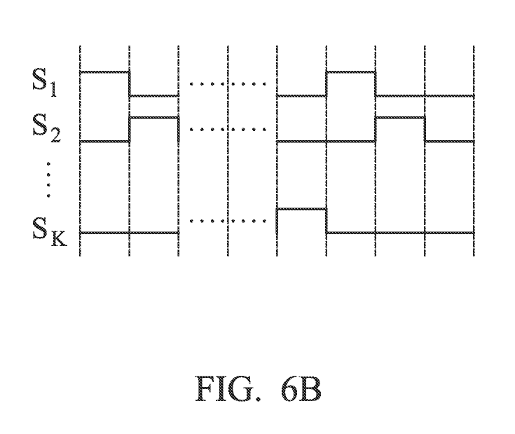

FIG. 6A shows an example of a K-path structure 600 according to another embodiment of the invention, and FIG. 6B shows a timing diagram illustrating the control signals S₁-S_{K} of the K-path structure of FIG. 6A. The K-path structure 600 comprises a plurality of passive switched capacitor units 610_1 to 610_K connected in parallel, wherein each passive switched capacitor unit has the same structure. Taking the passive switched capacitor unit 610_1 as an example, the passive switched capacitor unit 610_1 comprises four switches SW1, SW2, SW3 and SW4 and a capacitor C. The switch SW1 is coupled between an input of the passive switched capacitor unit 610_1 and a node N₁. The switch SW2 is coupled between the node N₁ and the ground GND. The switch SW3 is coupled between an output of the passive switched capacitor unit 610_1 and a node N₂. The switch SW4 is coupled between the node N₂ and the ground GND. Note that the switches SW1 and SW4 are controlled by the control signal S₁, and the switches SW2 and SW3 are controlled by the control signal S_{K}. The capacitor C is coupled between the node N₁ and the node N₂. For each tap of a FIR filter, its coefficient is determined according to the capacitors C of the K-path structure 600. In each of the passive switched capacitor units 610_1 to 610_K, the control signals S₁-S_{K} are not present at the same time. Furthermore, only one control signal is present in the K-path structure 600 at a time, as shown in FIG. 6B.

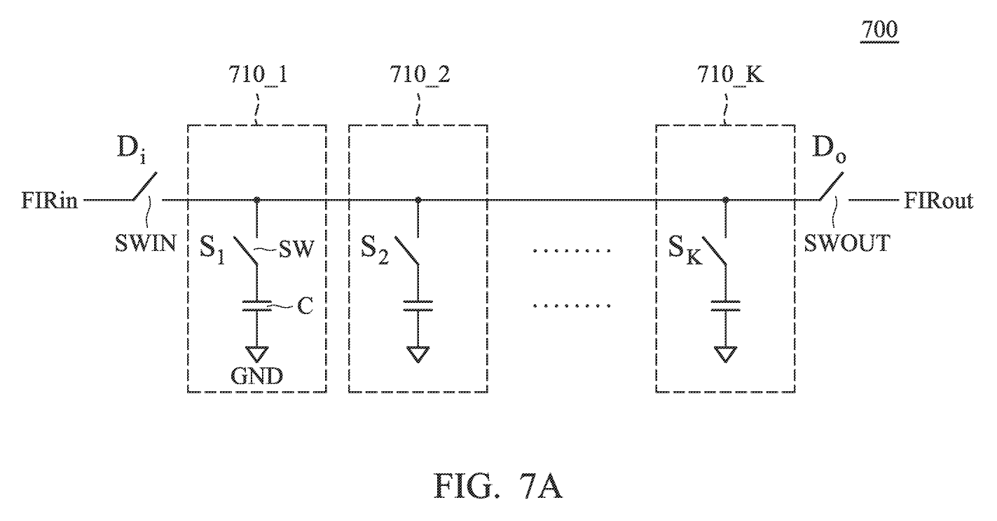

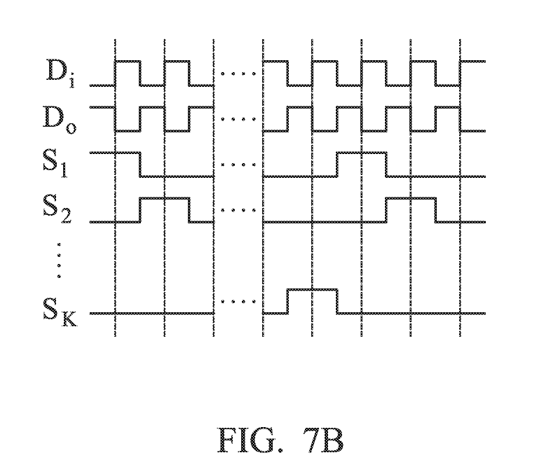

FIG. 7A shows an example of a K-path structure 700 according to another embodiment of the invention, and FIG. 7B shows a timing diagram illustrating the control signals S₁-S_{K}, Dᵢ and Dₒ of the K-path structure of FIG. 7A. The K-path structure 700 comprises two switches SWIN and SWOUT and a plurality of passive switched capacitor units 710_1 to 710_K connected in parallel. The switch SWIN is coupled between the input of the K-path structure 700 and the inputs of the passive switched capacitor units 710_1 to 710_K, and the switch SWOUT is coupled between the output of the K-path structure 700 and the switch SWIN. The switch SWIN is controlled by the control signal Dᵢ and the switch SWOUT is controlled by the control signal Dₒ complementary to the control signal Dᵢ. Each passive switched capacitor unit has the same structure. Taking the passive switched capacitor unit 710_1 as an example, the passive switched capacitor unit 710_1 comprises a switch SW and a capacitor C. The switch SW is coupled between an input of the passive switched capacitor unit 710_1 and the capacitor C, wherein the switch SW is controlled by the control signal S₁. The capacitor C is coupled between the switch SW and the ground GND. For each tap of a FIR filter, its coefficient is determined according to the capacitors C of the K-path structure 700. In each of the passive switched capacitor units 710_1 to 710_K, the control signals S₁-S₁ (are not present at the same time. Furthermore, only one control signal is present in the K-path structure 700 at a time, as shown in FIG. 7B.

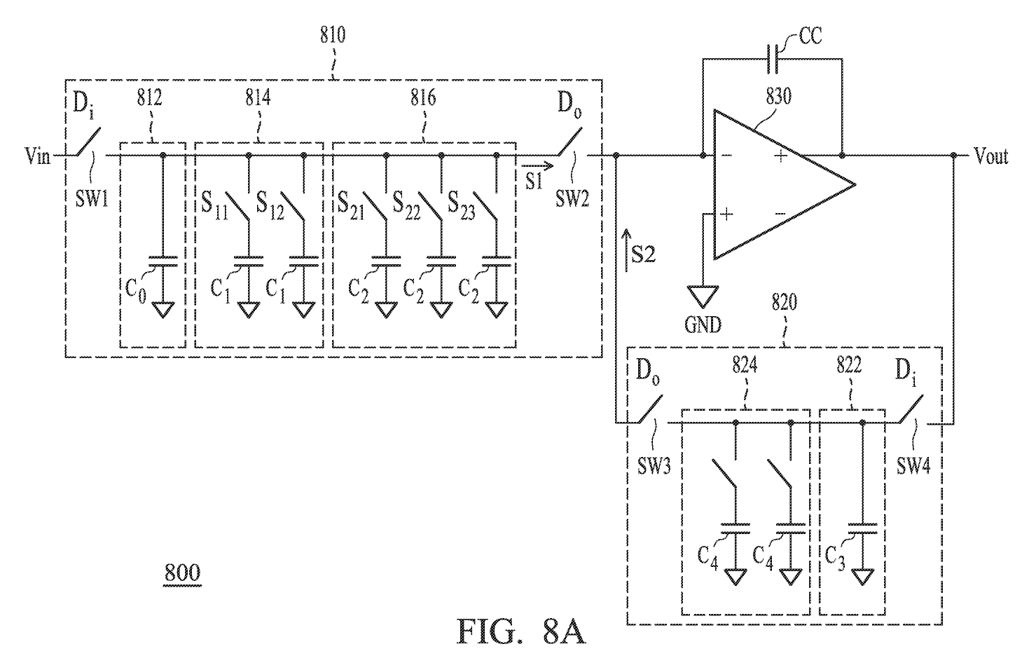

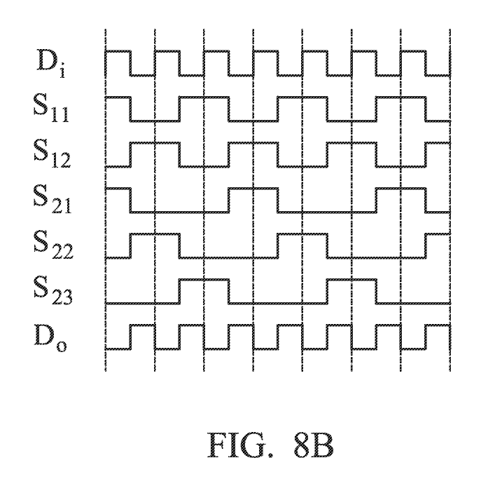

FIG. 8A shows an example of a 2^{nd} order IIR filter according to an embodiment of the invention, and FIG. 8B shows a timing diagram illustrating the control signals S₁₁, S₁₂, S₂₁, S₂₂, S₂₃, Dᵢ and Dₒ of the K-path structure of FIG. 8A. In the embodiment, the FIR filters 810 and 820 are implemented by the K-path structure 700 described in FIG. 7A. The FIR filter 810 is a 3-tap FIR filter which comprises two switches SW1 and SW2, a 1-path structure 812, a 2-path structure 814 and a 3-path structure 816. The FIR filter 820 is a 2-tap FIR filter which comprises two switches SW3 and SW4, a 1-path structure 822 and a 2-path structure 824. The switches SW1 and SW4 are controlled by the control signal Dᵢ and the switches SW2 and SW3 are controlled by the control signal Dₒ complementary to the control signal Dᵢ. Therefore, compared with the conventional switched capacitor biquad filter which is a feedback system, concerning two integrators for synthesizing two poles and two zeros, only one amplifier 830 is implemented in the IIR filter 800, thus power is saved. Furthermore, determining the capacitance value of each capacitor for the FIR filters 810 and 820 without considering total capacitance, capacitance spread, etc., is easier.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An infinite impulse response (IIR) filter, comprising:
an amplifier, for generating an output signal according to an input signal; and
a first filter coupled in a feedback path of the amplifier, for filtering the output signal according to a first transfer function and providing the filtered output signal to an input of the amplifier,
wherein the IIR filter and the first filter have the same order larger than one.

2. The IIR filter as claimed in claim 1, further comprising:
a second filter coupled to the input of the amplifier, for filtering out interference from the input signal according to a second transfer function.

3. The IIR filter as claimed in claim 2, further comprising:
a capacitor coupled between the input and an output of the amplifier and coupled to the first filter in parallel, such that the amplifier and the capacitor form an integrator.

4. The IIR filter as claimed in claim 3, wherein a transfer function of the IIR filter is
$$\frac{\frac{{z}^{- 1}}{1 - {z}^{- 1}} \times B ( z )}{1 - \frac{{z}^{- 1}}{1 - {z}^{- 1}} \times A ( z )} ,$$
wherein A(z) is the first transfer function, B(z) is the second transfer function and
$$\frac{{z}^{- 1}}{1 - {z}^{- 1}}$$
is a transfer function of the integrator.

5. The IIR filter as claimed in claim 2, wherein the first and second filters are finite impulse response (FIR) filters, and the poles and zeros of the IIR filter are determined according to the first transfer function and the second transfer function, respectively.

6. The IIR filter as claimed in claim 2, wherein a transfer function of the IIR filter is
$$\frac{B ( z )}{1 - {z}^{- 1} - {z}^{- 1} \times A ( z )} {z}^{- 1} ,$$
wherein A(z) is the first transfer function and B(z) is the second transfer function.

7. The IIR filter as claimed in claim 2, wherein the first and second filters are FIR filters, each implemented by a plurality of taps comprising passive switched capacitors.

8. An infinite impulse response (IIR) filter for providing an output signal according to an input signal, comprising:
a first filter, for filtering out interference from the input signal to generate a first signal according to a first transfer function;
a second filter, for filtering the output signal to generate a second signal according to a second transfer function; and
an integrator, for generating the output signal according to the first signal and the second signal,
wherein the second filter and the integrator form a negative feedback loop.

9. The IIR filter as claimed in claim 8, wherein the IIR filter and the second filter have the same order larger than one, and the poles and zeros of the IIR filter are determined according to the second transfer function and the first transfer function, respectively.

10. The IIR filter as claimed in claim 8, wherein the integrator comprises:
an amplifier having an inverting input for receiving the first and second signals, a non-inverting input coupled to a ground and an output for outputting the output signal; and
a capacitor coupled between the inverting input and the output of the amplifier.

11. The IIR filter as claimed in claim 8, wherein a transfer function of the IIR filter is
$$\frac{\frac{{z}^{- 1}}{1 - {z}^{- 1}} \times B ( z )}{1 - \frac{{z}^{- 1}}{1 - {z}^{- 1}} \times A ( z )} ,$$
wherein A(z) is the second transfer function, B(z) is the first transfer function and
$$\frac{{z}^{- 1}}{1 - {z}^{- 1}}$$
is a transfer function of the integrator.

12. The IIR filter as claimed in claim 8, wherein the first and second filters are finite impulse response (FIR) filters implemented by a plurality of taps comprising passive switched capacitors.

13. An infinite impulse response (IIR) filter for providing an output signal according to an input signal, comprising:
a first finite impulse response (FIR) filter, for transferring the input signal to generate a first signal;
a second FIR filter, for transferring the output signal to generate a second signal; and
an amplifier, for receiving the first signal and the second signal to generate the output signal,
wherein no amplifier is implemented in the first and second FIR filters.

14. The IIR filter as claimed in claim 13, wherein zeros of the IIR filter are determined by the first FIR filter, and poles of the IIR filter are determined by the second FIR filter.

15. The IIR filter as claimed in claim 14, wherein a transfer function of the IIR filter is
$$\frac{B ( z )}{1 - {z}^{- 1} - {z}^{- 1} \times A ( z )} {z}^{- 1} ,$$
wherein A(z) is the transfer function of the second FIR filter and B(z) is the transfer function of the first FIR filter.

16. The IIR filter as claimed in claim 14, further comprising:
a capacitor coupled between an input and an output of the amplifier and coupled to the second FIR filter in parallel, such that the amplifier and the capacitor form an integrator.

17. The IIR filter as claimed in claim 16, wherein a transfer function of the IIR filter is
$$\frac{\frac{{z}^{- 1}}{1 - {z}^{- 1}} \times B ( z )}{1 - \frac{{z}^{- 1}}{1 - {z}^{- 1}} \times A ( z )} ,$$
wherein A(z) is the transfer function of the second FIR filter, B(z) is the transfer function of the first FIR filter and
$$\frac{{z}^{- 1}}{1 - {z}^{- 1}}$$
is a transfer function of the integrator.

18. The IIR filter as claimed in claim 14, wherein each of the first and second FIR filters comprises a plurality of passive switched capacitor units, and each of the passive switched capacitor units comprises:
a first switch coupled between an input of the passive switched capacitor unit and a node;
a second switch coupled between an output of the passive switched capacitor unit and the node; and
a capacitor coupled between the node and a ground,
wherein one of the first and second switches is turned off when another of the first and second switches is turned on.

19. The IIR filter as claimed in claim 14, wherein each of the first and second FIR filters comprises a plurality of passive switched capacitor units, and each of the passive switched capacitor units comprises:
a first switch coupled between an input of the passive switched capacitor unit and a first node;
a second switch coupled between the first node and a ground;
a third switch coupled between an output of the passive switched capacitor unit and a second node;
a fourth switch coupled between the second node and the ground; and
a capacitor coupled between the first node and the second node,
wherein the first and fourth switches are controlled by a first control signal and the second and third switches are controlled by a second control signal, wherein the first and second control signals are not present at the same time.

20. The IIR filter as claimed in claim 14, wherein each of the first and second FIR filters comprises a plurality of passive switched capacitor units, and each of the passive switched capacitor units comprises:
a capacitor coupled to a ground; and
a switch coupled to the capacitor in series.

21. A filtering method for transferring an input signal to generate an output signal according to a transfer function of an infinite impulse response (IIR) filter, comprising:
transferring the input signal to generate a first signal according to a transfer function of a first finite impulse response (FIR) filter;
transferring the output signal to generate a second signal according to a transfer function of a second FIR filter; and
integrating a sum of the first and second signals to obtain the output signal,
wherein a transfer function of the IIR filter is
$$\frac{B ( z )}{1 - {z}^{- 1} - {z}^{- 1} \times A ( z )} {z}^{- 1} ,$$
wherein A(z) is the transfer function of the second FIR filter and
B(z) is the transfer function of the first FIR filter.
